(19) United States
(12) Patent Application Publication
(10) Pub. No.: US 2022/0184766 A1
(43) Pub. Date: Jun. 16, 2022

(54) PROCESSING ABNORMALITY DIAGNOSTIC DEVICE AND PROCESSING ABNORMALITY DIAGNOSTIC METHOD OF MACHINE TOOL

(71) Applicant: OKUMA CORPORATION, Niwa-Gun (JP)

(72) Inventor: Eisuke SOGABE, Niwa-Gun (JP)

(73) Assignee: OKUMA CORPORATION, Niwa-Gun (JP)

(21) Appl. No.: 17/457,105

(22) Filed: Dec. 1, 2021

(30) Foreign Application Priority Data
Dec. 15, 2020 (JP) 2020-207783

(51) Int. Cl. B23Q 17/09

(52) U.S. Cl. CPC B23Q 17/0995

(57) ABSTRACT

A processing abnormality diagnostic device includes an abnormality diagnostic unit that diagnoses whether processing is abnormal using an abnormality threshold by a preset diagnostic model, a success or failure input unit that inputs success or failure of the diagnosis of the abnormality by the abnormality diagnostic unit, a measure determination unit that determines a measure when the diagnosis of the abnormality is input as failure through the success or failure input unit, an abnormality threshold change unit that updates the abnormality threshold, and a learning unit that relearns the diagnostic model using operation information of the machine tool when the diagnosis of the abnormality has failed. The measure determination unit determines which of the abnormality threshold change unit and the learning unit is to be adopted as the measure based on the operation information diagnosed by the diagnostic model when the diagnosis of the abnormality has failed.

### BACKGROUND

This application claims the benefit of Japanese Patent Application Number 2020-207783 filed on Dec. 15, 2020, the entirety of which is incorporated by reference.

### TECHNICAL FIELD OF THE INVENTION

The disclosure relates to a processing abnormality diagnostic device and a processing abnormality diagnostic method that diagnose whether a processing state of a machine tool is abnormal based on an incorporated diagnostic model.

### DESCRIPTION OF RELATED ART

In processing by a machine tool, damage, such as a breakage and a fracture, of a tool in use leads to damage of a workpiece to be processed, and a defective workpiece is produced due to deterioration of accuracy and surface quality, thus resulting in a decrease in productivity. When a material of the workpiece to be processed is expensive, the damage causes a large loss in terms of material cost. Accordingly, there has been proposed a technique that measures a signal indicative of a processing state and classifies whether the processing state is normal to diagnose abnormality of the processing.

As the technique, for example, in JP-A-2019-67137, there has been proposed a technique that inputs working information of a machine and compares a feature value, which is generated using machine learning and output from a learning model, with a threshold to diagnose whether a state of a tool is normal or abnormal.

As in JP-A-2019-67137, for example, when abnormality in processing is missed in diagnosis for processing state using the learning model (a diagnostic model), adjustment of a threshold for a distinction between normality and abnormality or relearning of the learning model is required, but which should be selected cannot be grasped instantly. Therefore, man-hour of a person who analyzes a waveform of the feature value is taken and a learning work of the model becomes excessive. Accordingly, much time is taken to improve diagnosis accuracy, making the improvement difficult.

Therefore, in consideration of the issues, an object of the disclosure is to provide a processing abnormality diagnostic device and a processing abnormality diagnostic method of a machine tool that allow appropriately determining whether to adopt a measure of adjustment of a threshold or relearning when abnormality is missed.

### SUMMARY

In order to achieve the above-described object, a processing abnormality diagnostic device of machine tool according to a first aspect of the disclosure is provided. The processing abnormality diagnostic device is for diagnosing abnormality during processing in a machine tool that processes a workpiece using a tool. The processing abnormality diagnostic device includes an abnormality diagnostic unit, a success or failure input unit, a measure determination unit, an abnormality threshold change unit, and a learning unit. The abnormality diagnostic unit diagnoses whether the processing is abnormal using an abnormality threshold by a preset diagnostic model. The success or failure input unit inputs success or failure of the diagnosis of the abnormality by the abnormality diagnostic unit. The measure determination unit determines a measure when the diagnosis of the abnormality is input as failure through the success or failure input unit. The abnormality threshold change unit updates the abnormality threshold. The learning unit relearns the diagnostic model using operation information of the machine tool when the diagnosis of the abnormality has failed. The measure determination unit determines which of the abnormality threshold change unit and the learning unit is to be adopted as the measure based on the operation information diagnosed by the diagnostic model when the diagnosis of the abnormality has failed.

In another embodiment of the first aspect, which is in the above-described configuration, the diagnostic model used by the abnormality diagnostic unit is established by machine learning.

In another embodiment of the first aspect, which is in the above-described configuration, the abnormality diagnostic unit calculates an abnormality degree of the processing by the diagnostic model and compares the abnormality degree with the abnormality threshold to diagnose whether the processing is abnormal. The measure determination unit compares a differential value of the abnormality degree calculated by the diagnostic model with a preset differentiation threshold. The measure determination unit determines which of updating of the abnormality threshold by the abnormality threshold change unit or relearning of the diagnostic model by the learning unit is to be adopted based on a comparison result.

In another embodiment of the first aspect, which is in the above-described configuration, the abnormality threshold change unit identifies a time when the abnormality occurred using the operation information when the diagnosis of the abnormality has failed, and updates the abnormality threshold for enabling the diagnostic model to detect the abnormality at the time.

In another embodiment of the first aspect, which is in the above-described configuration, the success or failure of the diagnosis of the abnormality is input through the success or failure input unit using at least any one of a measurement result of a tool state using a sensor, a quality inspection result of the processed workpiece, and a result of observation of the processing by a person.

In order to achieve the above-described object, a processing abnormality diagnostic method according to a second aspect of the disclosure is provided. The processing abnormality diagnostic method is for diagnosing abnormality during processing in a machine tool that processes a workpiece using a tool. The processing abnormality diagnostic method includes an abnormality diagnostic step of diagnosing whether the processing is abnormal using an abnormality threshold by a preset diagnostic model, a success or failure input step of inputting success or failure of the diagnosis of the abnormality by the abnormality diagnostic step, and a measure determination step of determining a measure against failure based on operation information of the machine tool diagnosed by the diagnostic model when the diagnosis of the abnormality is input as the failure by the success or failure input step. The processing abnormality diagnostic method further includes a step of performing one of an abnormality threshold change step of updating the abnormality threshold selected by the determination by the measure determination step and a learning step of relearning the diagnostic model using the operation information.

The disclosure can appropriately determine whether to adopt the measure of adjustment of the threshold or the learning based on the operation information diagnosed by the diagnostic model when the abnormality is missed. Accordingly, a work to improve diagnosis accuracy of the diagnostic model can be automated to ensure the increased improvement efficiency of diagnosis performance.

### BRIEF DESCRIPTION OF THE DRAWINGS

FIG. 1 is a block configuration diagram of a machine tool and a processing abnormality diagnostic device.

FIG. 2 is a flowchart depicting a processing abnormality diagnostic method.

FIG. 3 is an explanatory diagram illustrating a processing torque waveform and an abnormality degree waveform when abnormality is missed.

### DETAILED DESCRIPTION

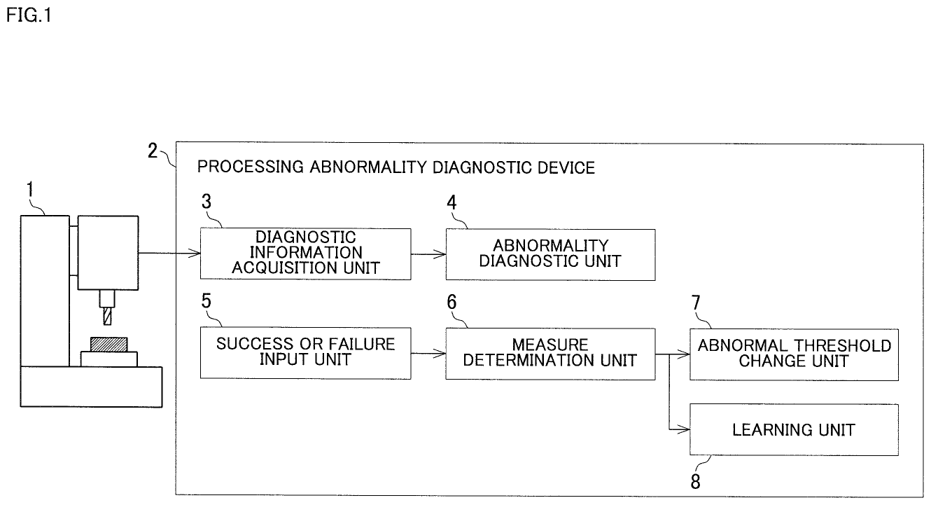

The following will describe embodiments of the disclosure based on the drawings. FIG. 1 is a block configuration diagram illustrating an example of a processing abnormality diagnostic device of the disclosure. Here, a processing abnormality diagnostic device 2 is provided with a machine tool 1. The processing abnormality diagnostic device 2 may be incorporated into a control device (not illustrated) of the machine tool 1.

The processing abnormality diagnostic device 2 includes a diagnostic information acquisition unit 3 and an abnormality diagnostic unit 4. The diagnostic information acquisition unit 3 obtains control information of the machine tool 1 and measurement signals from various sensors (not illustrated) as diagnostic information. The abnormality diagnostic unit 4 stores a diagnostic model that calculates an abnormality degree based on the diagnostic information, which is obtained by the diagnostic information acquisition unit 3. The abnormality diagnostic unit 4 determines whether processing is normal or abnormal through determination of comparison of the abnormality degree output based on the input diagnostic information (operation information) with an abnormality threshold. The diagnostic model is established by machine learning.

The processing abnormality diagnostic device 2 includes a success or failure input unit 5, a measure determination unit 6, an abnormality threshold change unit 7, and a learning unit 8.

The success or failure input unit 5 is provided for an operator to input a determination result of whether the diagnosis of abnormality has succeeded (avoidance of abnormality) or the diagnosis of abnormality has failed (missed). The determination result input through the success or failure input unit 5 is input to the measure determination unit 6.

The measure determination unit 6 determines whether to change the abnormality threshold for determination of the abnormality degree or relearn the diagnostic model based on the determination result input through the success or failure input unit 5.

When the change of the abnormality threshold is determined to be necessary by the measure determination unit 6, the abnormality threshold change unit 7 redetermines the abnormality threshold from the diagnostic information and changes the abnormality threshold.

When the relearning of the diagnostic model is determined to be necessary by the measure determination unit 6, the learning unit 8 gives a label of abnormality to the diagnostic information, performs relearning, and updates the diagnostic model.

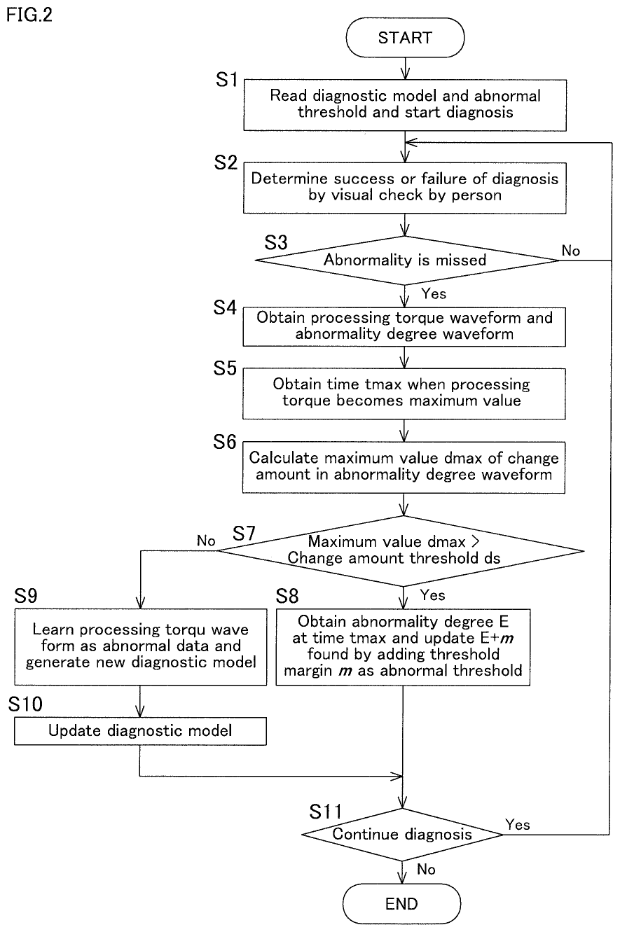

The following will describe details of a processing abnormality diagnostic method by the processing abnormality diagnostic device 2 based on the flowchart in FIG. 2.

First, at S1, the abnormality diagnostic unit 4 reads the diagnostic model and the abnormality threshold and starts diagnosis of abnormality or normality based on the diagnostic information obtained from the diagnostic information acquisition unit 3 (an abnormality diagnostic step). The diagnostic result is output to a monitor (not illustrated) or the like.

Next, at S2, an operator visually checks the diagnostic result, determines whether the abnormality is missed, and inputs the determination result through the success or failure input unit 5 (a success or failure input step).

Next, at S3, the measure determination unit 6 determines the input at S2, returns the process to S1 when the abnormality is not missed, and performs the diagnosis again. When the abnormality is missed, a processing torque waveform and an abnormality degree waveform used for the diagnosis are obtained at S4.

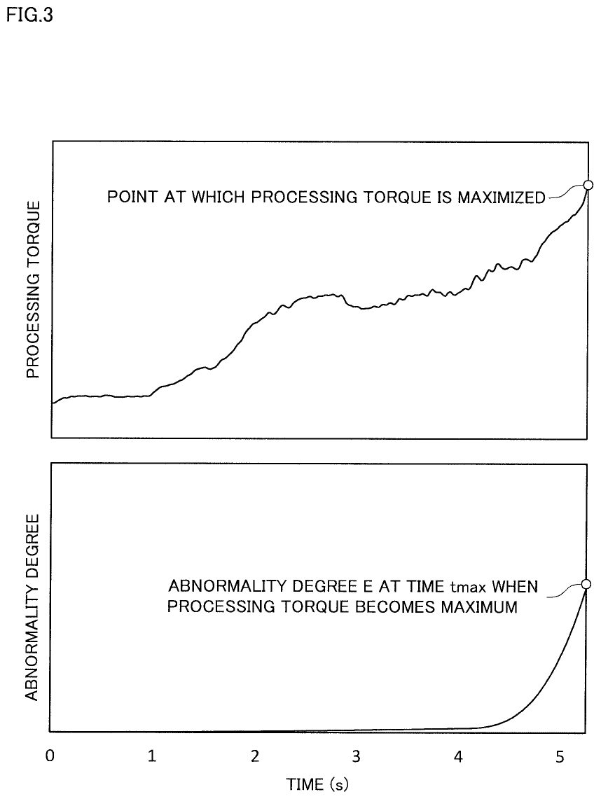

Next, at S5, the measure determination unit 6 obtains a point at which the processing torque becomes the maximum value, that is, a time tmax when the processing abnormality occurs, and cuts out the waveform in a time period range from the start time to the time tmax of the waveform (illustrated in FIG. 3). The measure determination unit 6 differentiates the abnormality degree and calculates a maximum value dmax of a change amount in the abnormality degree at S6, and compares the maximum value dmax with a preset change amount threshold ds (a differentiation threshold) at S7 (S3 to S5: a measure determination step).

In a case where the maximum value dmax exceeds the change amount threshold ds in the comparison result at S7, the abnormality threshold change unit 7 obtains an abnormality degree E (illustrated in FIG. 3) at the time of the time tmax, and updates a value found by adding a preset threshold margin m to the abnormality degree E as the abnormality threshold at S8 (an abnormality threshold change step).

On the other hand, in a case where the maximum value dmax does not exceed the change amount threshold ds in the comparison result at S7, the learning unit 8 gives an abnormality label to the processing torque waveform (illustrated in FIG. 3) and performs learning to generate a new diagnostic model at S9. At S10, a model detecting the abnormality is updated to the new diagnostic model generated at S9 (S9 and S10: a learning step).

When the diagnosis is continued at S11, the process is returned to S1, and when the diagnosis is not continued, the process is ended.

Thus, with the processing abnormality diagnostic device 2 and the processing abnormality diagnostic method according to the configuration, there are provided the abnormality diagnostic unit 4, the success or failure input unit 5, the measure determination unit 6, the abnormality threshold change unit 7, and the learning unit 8. The abnormality diagnostic unit 4 diagnoses whether the processing is abnormal using the abnormality threshold by the preset diagnostic model. The success or failure input unit 5 is to input the success or failure of the diagnosis of the abnormality by the abnormality diagnostic unit 4. The measure determination unit 6 determines the measure when the diagnosis of the abnormality is input as failure through the success or failure input unit 5. The abnormality threshold change unit 7 updates the abnormality threshold. The learning unit 8 relearns the diagnostic model using the operation information of the machine tool 1 when the diagnosis of the abnormality has failed. The measure determination unit 6 determines which of the abnormality threshold change unit 7 and the learning unit 8 is to be adopted as the measure when the diagnosis of the abnormality is input as the failure based on the operation information diagnosed by the diagnostic model when the diagnosis of the abnormality has failed.

The configuration can appropriately determine whether to adopt the measure of adjustment of the threshold or learning based on the operation information diagnosed by the diagnostic model when abnormality is missed. Accordingly, a work to improve diagnosis accuracy of the diagnostic model can be automated to ensure the increased improvement efficiency of diagnosis performance.

The input through the success or failure input unit in the disclosure is not limited to the result of visual check of the processing state by a person. The use of a success or failure signal as a result of diagnosis based on one or a plurality of results, such as a measurement result of a tool length by a tool length measurement device, a process result of an image of a tool or a workpiece obtained by photographing with a camera, and a quality inspection result of a processed workpiece, does not cause any problem.

The diagnostic model used in the disclosure only needs to be a mathematical model generated using a machine learning technique, such as a neural network. Furthermore, the use of a filter that performs smoothing on the obtained waveform as necessary in the measure determination unit does not cause any problem.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A processing abnormality diagnostic device of machine tool for diagnosing abnormality during processing in a machine tool that processes a workpiece using a tool, the processing abnormality diagnostic device comprising:
an abnormality diagnostic unit that diagnoses whether the processing is abnormal using an abnormality threshold by a preset diagnostic model;
a success or failure input unit that inputs success or failure of the diagnosis of the abnormality by the abnormality diagnostic unit;
a measure determination unit that determines a measure when the diagnosis of the abnormality is input as failure through the success or failure input unit;
an abnormality threshold change unit that updates the abnormality threshold; and
a learning unit that relearns the diagnostic model using operation information of the machine tool when the diagnosis of the abnormality has failed, wherein
the measure determination unit determines which of the abnormality threshold change unit and the learning unit is to be adopted as the measure based on the operation information diagnosed by the diagnostic model when the diagnosis of the abnormality has failed.

2. The processing abnormality diagnostic device of machine tool according to claim 1, wherein
the diagnostic model used by the abnormality diagnostic unit is established by machine learning.

3. The processing abnormality diagnostic device of machine tool according to claim 2, wherein
the abnormality diagnostic unit calculates an abnormality degree of the processing by the diagnostic model and compares the abnormality degree with the abnormality threshold to diagnose whether the processing is abnormal, and
the measure determination unit compares a differential value of the abnormality degree calculated by the diagnostic model with a preset differentiation threshold, and the measure determination unit determines which of updating of the abnormality threshold by the abnormality threshold change unit or relearning of the diagnostic model by the learning unit is to be adopted based on a comparison result.

4. The processing abnormality diagnostic device of machine tool according to claim 1, wherein
the abnormality threshold change unit identifies a time when the abnormality occurred using the operation information when the diagnosis of the abnormality has failed and updates the abnormality threshold for enabling the diagnostic model to detect the abnormality at the time.

5. The processing abnormality diagnostic device of machine tool according to claim 1, wherein
the success or failure of the diagnosis of the abnormality is input through the success or failure input unit using at least any one of a measurement result of a tool state using a sensor, a quality inspection result of the processed workpiece, and a result of observation of the processing by a person.

6. A processing abnormality diagnostic method of machine tool for diagnosing abnormality during processing in a machine tool that processes a workpiece using a tool, the processing abnormality diagnostic method comprising:
diagnosing whether the processing is abnormal using an abnormality threshold by a preset diagnostic model;
inputting success or failure of the diagnosis of the abnormality by the diagnosing;
determining a measure against failure based on operation information of the machine tool diagnosed by the diagnostic model when the diagnosis of the abnormality is input as the failure by the inputting; and
performing one of updating the abnormality threshold selected by the determination by the determining and relearning the diagnostic model using the operation information.
